(19) United States
(12) Patent Application Publication
(10) Pub. No.: US 2024/0430993 A1
(43) Pub. Date: Dec. 26, 2024

(54) HEATING SYSTEM

(71) Applicant: Dyson Technology Limited, Wiltshire (GB)

(72) Inventors: Daniel James Bernard SMITH, Newcastle upon Tyne (GB); Barrie Charles MECROW, Newcastle upon Tyne (GB); Mark TURNER, Newcastle upon Tyne (GB)

(21) Appl. No.: 18/690,410

(22) PCT Filed: Sep. 7, 2022
(86) PCT No.: PCT/GB2022/052274

§ 371 Date: Mar. 8, 2024

(30) Foreign Application Priority Data
Sep. 10, 2021 (GB) 2112919.2

(51) Int. Cl. H05B 6/06; H05B 6/10

(52) U.S. Cl. CPC H05B 6/06; H05B 6/105

(57) ABSTRACT

A heating system is provided. The heating system comprises an induction heating assembly configured to generate varying magnetic fields, a heating target assembly comprising a plurality of heating targets, the plurality of heating targets being heatable by penetration with a varying magnetic field. A first subset of the plurality of heating targets has a first resonant heating characteristic and a second subset of the plurality of heating targets has a second resonant heating characteristic, and the first and second resonant heating characteristics are different. The system further comprises a controller configured to: control the induction heating assembly based on the first resonant heating characteristic to generate a first varying magnetic field to heat the first subset and control the induction heating assembly based on the second resonant heating characteristic to generate a second varying magnetic field to heat the second subset.

### TECHNICAL FIELD

The present invention relates to a heating system for heating an entity. The invention may find particular use in a hair straightening or curling device for heating hair.

### BACKGROUND

Induction heating is a process whereby an electrically conducting object is heated by electromagnetic induction in which a varying/alternating magnetic field is produced. The magnetic field penetrates the electrically conductive object, and induces eddy currents within the object. These eddy currents flow through the object and heat the object via Joule heating. In some examples, the object may also be ferromagnetic, such that additional heat is generated by magnetic hysteresis.

### SUMMARY

According to an aspect of the present invention there is provided a heating system, comprising an induction heating assembly configured to generate varying magnetic fields, and a heating target assembly comprising a plurality of heating targets, the plurality of heating targets being heatable by penetration with a varying magnetic field. A first subset of the plurality of heating targets has a first resonant heating characteristic and a second subset of the plurality of heating targets has a second resonant heating characteristic, the first and second resonant heating characteristics being different. The heating system further comprises a controller configured to: (i) control the induction heating assembly based on the first resonant heating characteristic to generate a first varying magnetic field to heat the first subset, and (ii) control the induction heating assembly based on the second resonant heating characteristic to generate a second varying magnetic field to heat the second subset.

Accordingly, the heating system comprises two different “types” of heating targets (i.e. the first and second subset) that can elicit different heating responses by being penetrated with different magnetic fields. For example, the first subset of heating targets may be made of a first material and the second subset of heating targets may be made of a second, different material. The induction heating assembly may be operated in a particular manner so that the first subset of heating targets are inductively heated while the second subset of heating targets are not heated, or are heated to a lower temperature than the first subset. Alternatively, or at a later moment in time, the induction heating assembly may be operated in a different manner so that the second subset of heating targets are inductively heated while the first subset of heating targets are not heated, or are heated to a lower temperature than the second subset. In some examples, the induction heating assembly may be operated in a particular manner so that both subsets are heated at substantially the same time, but are heated to different temperatures. Other examples are also possible.

In an example, each subset comprises one or more heating targets. For example, the plurality of heating targets may comprise two heating targets and each subset comprises one heating target. In another example, each subset comprises two or more heating targets. The subsets may contain the same number of heating targets or a different number of heating targets.

In the above heating system, the heating target assembly is arranged within magnetic proximity of the induction heating assembly to ensure that adequate heating can take place. The heating system may be used to heat an entity such as hair, a fluid, air, liquid, water or foodstuffs, among other examples. Heat is transferred to the entity via the heating target assembly which may be brought within thermal proximity of the entity. In examples, the heating target assembly is a heating plate or a cooking receptacle, such as a pan.

In an example, the heating system is a heating device, such as an induction heating device.

The varying magnetic field may be an alternating magnetic field, in some examples. The magnetic field may vary in time and/or in space.

The controller may comprise one or more sub-controllers or processors.

In some examples, the induction heating assembly comprises at least one induction coil. The induction coil may form part of an induction coil assembly comprising a plurality of induction coils, for example. Thus, the induction heating assembly may comprise an induction coil assembly.

As will be well understood, in induction heating systems, a heating target can be heated most efficiently when the heating target is heated “resonantly”. For example, the induction heating assembly may comprise a drive circuit configured to generate an alternating current of a particular frequency to drive the induction heating assembly (such as an induction coil assembly) to produce the varying/alternating magnetic field. The frequency of the alternating current may be known as the drive frequency. A controller may select and/or adjust the drive frequency. In some examples, the induction heating assembly comprises a resonant circuit driven by the drive circuit, where the resonant circuit comprises the at least one induction coil. The resonant circuit may comprise at least one capacitor. The resonant circuit may be known as an RLC circuit.

A heating target can be heated resonantly when the drive frequency matches the resonant frequency of the induction system, where the induction system comprises the induction heating assembly and one or more heating targets or a subset of heating targets. The resonant frequency of the induction system depends on various properties of the heating target being heated. As such, each heating target or each subset of similar heating targets may have inherent resonant heating characteristics. These can be different to other heating targets within the heating system.

Accordingly, resonant heating characteristics determine how the heating targets within a particular subset behave when inductively heated. For example, due to the different properties of the heating targets in each subset, heating targets within the first subset may be part of a first induction system having a first resonant frequency when located at a particular distance away from the induction heating assembly, while the heating targets within the second subset may be part of a second induction system having a second, different resonant frequency when located at the particular distance away from the induction heating assembly.

It will be appreciated that other factors can affect the resonant frequency of an induction system, such as distance of the one or more heating targets from the induction heating assembly. Accordingly, the first and second heating characteristics discussed above are due to the inherent physical properties of the heating targets, such as the material/composition of the heating targets within the subset.

By having different resonant heating characteristics, which results in the induction systems having different resonant frequencies, the heating of the subsets can be controlled by adjusting the drive frequency of the induction heating assembly. For example, the first subset can be heated at or close to resonance by operating the induction heating assembly at a first drive frequency, and the second subset can be heated at or close to resonance by operating the induction heating assembly at a second, different drive frequency, where the first and second drive frequencies substantially match the first and second resonant frequencies, respectively.

Accordingly, in some examples, to control the induction heating assembly, the controller is configured to: (i) cause the induction heating assembly to be driven at a first drive frequency to generate the first magnetic field, and (ii) cause the induction heating assembly to be driven at a second drive frequency to generate the second magnetic field, wherein the first and second drive frequencies are based on at least the first and second resonant heating characteristics. In examples, the first and second drive frequencies are different.

Being based on at least the first and second resonant heating characteristics may mean that the drive frequencies are selected to substantially match a resonant frequency of the induction system comprising the particular subset of heating targets. In other examples, the drive frequencies may be selected to be sufficiently far away from the resonant frequency of the particular subset of heating targets. Choosing a drive frequency that is sufficiently far away from the resonant frequency may be useful to heat the targets to a lower temperature. Temperature can also be controlled by controlling the duty cycle of the induction heating assembly. For example, a subset may be heated to a lower average temperature by decreasing the duty cycle (i.e. by generating the magnetic field for a shorter time).

In some examples, the induction heating assembly comprises a single heating zone comprising an induction coil assembly that generates both the first and second varying magnetic fields. The heating zone (and therefore the induction heating assembly) can generate one varying magnetic field at a particular moment in time.

In contrast, an induction heating assembly comprising two or more heating zones, each zone comprising an induction coil assembly, could generate two or more varying magnetic fields at a particular moment in time. In the single heating zone example, the induction heating assembly may be driven at the first and second drive frequencies by varying the drive frequency in time (i.e. by multiplexing the different drive frequencies in time). In the example comprising a plurality of heating zones, the induction heating assembly may be driven at the first and second drive frequencies at the same time. Alternatively, the induction heating assembly may be driven at the first and second drive frequencies at different, non-overlapping times (i.e. by multiplexing the different drive frequencies in time). Thus, even in examples comprising a plurality of heating zones, the magnetic fields may be generated at different times. This may be useful to avoid interference between the different (such as the first and second) magnetic fields, for example. In addition, this allows the heating zones to have a higher peak power to enable the average power to remain the same. This can be useful to concentrate that average power in parts of the heating target assembly where it is needed. This is in contrast to operating all of the heating zones at the same time, which limits the amount of power for each zone (which is particularly important if there is a power limit on the power supply (such as the battery). By alternating which heating zones are on can deliver more even heating at a higher efficiency. Having a plurality of heating zones, rather than a single heating zone may also simplify operation of the device. For example, it may be simpler to operate two heating zones rather than adjusting the drive the frequency of a single heating zone. In some examples, the circuitry components of a heating zone may be specifically designed and configured to operate at or within a range of a particular drive frequency such that the zone is incapable of operating at a different drive frequency.

In either case, the different subsets of heating targets are heated substantially independently to maintain desired temperatures or to maintain a desired overall temperature.

In some examples, causing the induction heating assembly to be driven at a drive frequency may also comprise the controller selecting the drive frequency, where the drive frequency is selected based on at least the resonant heating characteristic of the particular subset.

In a particular example, the induction heating assembly comprises a first heating zone and a second heating zone, the first heating zone being configured to generate the first varying magnetic field and the second heating zone being configured to generate the second varying magnetic field, and wherein to control the induction heating assembly, the controller is configured to: (i) cause the first heating zone to be driven at the first drive frequency to generate the first magnetic field and (ii) cause the second heating zone to be driven at the second drive frequency to generate the second magnetic field. In some examples, the induction heating system comprises a (single) drive circuit to drive the first and second heating zones at different drive frequencies.

In an example, each heating zone comprises resonant circuit comprising an induction coil or induction coil assembly. Each resonant circuit may further comprise at least one capacitor. Similarly, each heating zone may comprise its own drive circuit to drive the resonant circuit. In another example, a single drive circuit may drive a plurality of resonant circuits. For example, a plurality (such as first and second) resonant circuits may be connected in parallel which are connected to a single drive circuit. Such a circuit design is particularly efficient at allowing each heating zone to be controlled independently because the different drive frequencies can be effectively multiplexed in time.

The heating system may further comprise one or more controllers to control operation of the plurality of heating zones. The, or each, controller may comprise one or more processors, including one or more microprocessors, central processing units and/or graphical processing units, and a set of memory.

In some examples, each heating zone is independently controllable. For example, each heating zone can be driven at different drive frequencies, although in some circumstances one or more heating zones may be independently driven at the same drive frequency at the same time.

In one example, to control the induction heating assembly, the controller is configured to: (i) cause the induction heating assembly to be driven at the first drive frequency to generate the first magnetic field for a first time period, and (ii) cause the induction heating assembly to be driven at the second drive frequency to generate the second magnetic field for a second time period.

In the example where there is a single heating zone, the first and second time periods may be sequential in time, or may have a gap between them (i.e. they are spaced apart in time by a gap).

In the example where there are two or more heating zones, such as the first and second heating zones, the first and second periods may fully or partially overlap in time, or may not overlap in time such that the periods are sequential in time or may have a gap between them. In a particular example, the first zone is driven at the first frequency for the first time period and second zone is driven at the second frequency for the second time period.

In a particular example, the first and second time periods are based on the thermal time constant to regulate the temperature to within a particular tolerance. In some examples, a pause or gap between operating the different zones allows a temperature measurement to be taken.

In one example, the first subset of the plurality of heating targets and the induction heating assembly form a first induction system having a first resonant frequency based on at least the first resonant heating characteristic and the second subset of the plurality of heating targets and the induction heating assembly form a second induction system having a second resonant frequency based on at least the second resonant heating characteristic.

As mentioned, the first and second resonant heating characteristics are based on various properties of the heating target(s) within each subset. Accordingly, the first and second resonant heating characteristics may be based on at least one of: (i) materials/compositions of the one or more heating targets in the first or second subsets, (ii) thicknesses of the one or more heating targets in the first or second subsets, (iii) densities of the one or more heating targets in the first or second subsets, (iv) permeabilities of the one or more heating targets in the first or second subsets, (v) dimensions of the one or more heating targets in the first or second subsets and (vi) surface features and/or patterns on the one or more heating targets in the first or second subsets. External factors that also affect the resonant frequencies include: distance between the heating target and the induction assembly, the shape of the induction coil(s), the number of turns in the induction coil(s) and interference from neighbouring induction coil(s).

In one example, the first subset of heating targets are made of (or comprise) a material selected from: Aluminium, Copper, Steel, Titanium, Beryllium Copper, Bronze, Brass, Graphite or Pyrolytic Graphite and the second subset of heating targets are made of (or comprise) a material selected from: Aluminium, Copper, Steel, Titanium, Beryllium Copper, Bronze, brass Graphite or Pyrolytic graphite and the first and second subsets are made from different materials. In some examples the first and second subsets are made of materials having substantially different resistivities.

In one example, at least one heating target from the first subset of the plurality of heating targets is arranged between heating targets from the second subset of the plurality of heating targets. In other words, there may be one or more heating targets from the first subset arranged in the middle (or within) the heating targets from the second subset. The heating targets may therefore be arranged in an alternating arrangement. This could mean that different regions of the heating target assembly can be heated at different times, which, in some examples, may reduce or limit heat flow between the different regions. For example, if the different subset of heating targets are arranged in an alternating fashion along the length and/or width of the heating target assembly (such as: FSF or FSFS or FSFSFS etc.), the different regions can be heated to different temperatures. For example, operating at the first drive frequency at a particular moment in time may heat the regions containing heating targets from the first subset (F) to a first temperature, while the regions containing heating targets from the second subset(S) may not be heated or may be heated to a different temperature. Similarly, operating at the second drive frequency at the particular moment in time or at a later moment in time may heat the regions containing heating targets from the second subset (S) to a second temperature, while the regions containing heating targets from the first subset (F) may not be heated or may be heated to a different temperature. Accordingly, operating at different drive frequencies based on the first and second resonant heating characteristics can allow different regions of the heating target assembly to be heated differently, thereby providing greater control over the heating.

In a particular example, the difference between the first and second drive frequencies is greater than about 10 kHz. By ensuring that the minimum difference between the drive frequencies (and therefore the resonant frequencies) is greater than 10 kHz allows one subset to be heated while avoiding or reducing the extent to which the other subset is heated.

In some examples, the plurality of heating targets are moveable relative to the induction heating assembly, and wherein at least one of: (i) the first drive frequency is further based on the position of the first subset of the plurality of heating targets relative to the induction heating assembly (such as the induction coil assembly), and (ii) the second drive frequency is further based on the position of the second subset of the plurality of heating targets relative to the induction heating assembly (such as the induction coil assembly).

In a particular example, at least one of: (i) the first drive frequency is varied as the position of the first subset of the plurality of heating targets moves relative to the induction heating assembly and (ii) the second drive frequency is varied as the position of the second subset of the plurality of heating targets moves relative to the induction heating assembly.

Accordingly, the heating system may comprise a heating target assembly which can move, or parts of which can move, relative to the induction heating assembly and therefore relative to the magnetic flux generated by the induction heating assembly. Moving one or more heating targets closer or further away from the induction heating assembly can further allow the heating of the heating targets to be controlled. As briefly mentioned above, the resonant frequency of an induction system is based on the position of the heating targets relative to the induction heating assembly and thus changes depending upon the distance between the heating targets and the induction heating assembly. Accordingly, the drive frequency may further be based on the position of the heating target(s) of the particular subset.

In some examples, all of the one or more heating targets are collectively moveable but in other examples the subsets of the heating targets are independently moveable.

In some examples, the heating target assembly is flexible. The flexible nature of the heating target assembly thereby permits the movement relative to the induction heating assembly. The heating targets therefore form at least part of the flexible heating target assembly. The heating target assembly may be articulated or the plurality of heating targets may be embedded within a flexible substrate such as a membrane to permit movement. In some examples, one or more of the plurality of heating targets are rigid, and each target can move relative to a neighbouring heating target. In some examples, one or more of the plurality of heating targets are themselves flexible.

Having a heating target assembly that is flexible allows the heating to be controlled through movement of the heating targets relative to the induction heating assembly while also allowing the heating target assembly to conform to the object being heated. For example, if the heating system forms part of a hair styling device, the heating target assembly can flex/bend due to contact with hair. Conforming to the hair can reduce damage to the hair caused by over compression while also allowing the heat to be distributed move evenly around the hair.

In an example, the heating targets are moveable between a first position and a second position, the second position being closer to the induction heating assembly than the first position.

In a particular example, the heating targets are biased towards the first position and are moveable towards the second position. This arrangement may be particularly useful if the heating targets are heated to a greater extent when located in the second position (i.e. closer to the induction heating assembly) because it ensures that the default position undergoes less heating, which can improve safety. For example, if the heating system is part of a hair styling device, the heating targets may be heated to a greater extent when the heating targets are moved closer to the induction heating system via contact with hair and the heating targets are therefore biased towards the first position in absence of the hair. Accordingly, in an example, the heating targets are deflectable towards the second position.

In certain examples, when a region of the heating target assembly is arranged in the first position, the region is heated to a lower temperature than when the region arranged in the second position. The region may include part of a single heating target or one or more heating targets (such as a subset of heating targets or one or more subsets). Accordingly, in a particular arrangement, the heating system may be configured such that greater heating occurs when the region is closer to the induction heating assembly. In some examples, while the region is arranged in the first position, another region of the heating target assembly is arranged in the second position. Thus, different regions of the heating target assembly may be heated to different temperatures simultaneously due to the moveable or flexible nature of the heating target assembly. This again allows greater control over the heating.

The position of the heating targets can be determined or inferred through measurement. In one example, the drive frequency may be selected so as to always heat the subset of targets resonantly (i.e. to substantially match the resonant frequency of the region/subset being heated, where the resonant frequency is a function of the position of the region relative to the induction heating assembly). The drive frequency can therefore be varied as the position of the subset of heating targets move relative to the induction heating assembly.

As briefly mentioned, in some examples, at least one of the heating targets are rigid. Having one or more rigid targets may mean that the targets are less prone to breakage. In another example, at least one of the heating targets are flexible. Having one or more flexible heating targets can mean that they conform more closely to the entity being heated, such as hair.

In certain arrangements, in use, the heating targets are moved/moveable due to contact with an entity being heated. The heating targets may therefore not be actively moved by components of the system, but are passively moved via contact with the entity being heated. In an example where the heating system forms part of a hair styling device, the heating target assembly may be brought into contact with hair and the volume of hair causes a region of the heating target assembly to be moved. Thus, the presence of the entity being heated can therefore indirectly control the heating.

In other arrangements, the heating system comprises an adjustment assembly configured to move the heating targets relative to the induction heating assembly. Thus, in contrast to the passive movement described above, the adjustment assembly can adjust the position of the heating targets relative to the induction heating assembly as desired. This arrangement can allow the heating targets to be moved without needing to be moved by the entity being heated, thus allowing more direct control over the heating.

In certain arrangements, the induction heating assembly comprises a top side facing towards the heating targets, and a bottom side facing away from the heating targets, wherein the varying magnetic field is asymmetric such that the magnetic field strength at the top side is substantially greater than the magnetic field strength at the bottom side. In one example, a ratio of the magnetic field strength at the top side to the magnetic field strength at the bottom side is greater than about 100. More preferably, the ratio of the magnetic field strength at the top side to the magnetic field strength at the bottom side is greater than about 1000.

In a particular example, the induction heating assembly comprises an induction coil assembly, and it is the induction coil assembly that has the top side facing towards the heating target assembly, and the bottom side facing away from the heating target assembly.

Accordingly, the induction heating assembly produces a substantially “single-sided” magnetic field in which there is a strong magnetic field produced only at the top side of the induction heating assembly. Preferably there is no magnetic field produced at the bottom side of the induction heating assembly, or the magnetic field strength at the bottom is small or negligible compared to the magnetic field strength at the top side. Thus, a high proportion of the magnetic energy is directed towards the heating target assembly. This asymmetric, or single-sided, magnetic field therefore provides a more energy efficient heating process by reducing the amount magnetic energy being lost in other directions. Energy efficiency is particularly important when the heating system is part of a device that has a battery power source. The single-sided or asymmetric magnetic field may be analogous to a Halbach array of permanent magnets.

In addition, because the magnetic field is directed substantially towards the heating target assembly, the magnetic flux escaping the device can be greatly reduced. This reduces the need for bulky, heavy and expensive magnetic shielding. The device can therefore be made safer, without compromising on size and portability. The use of an asymmetric magnetic field can allow the device to meet certain consumer product safety standards (such as IEC 60335) with no or minimal magnetic shielding. Thus, the use of an asymmetric magnetic field finds particular advantages in a device which is brought into close proximity to a user's head and/or jewellery.

In examples, the one or more heating targets each have a thickness of less than about 5 mm or less than about 3 mm, or less than about 2 mm, or less than about 1 mm, or less than about 0.5 mm.

In some examples, the heating target assembly comprises a surface that is brought into contact with the entity being heated, such as hair. In an example, the surface is smooth and continuous. However, it may sometimes be useful to limit heat flow along the surface to avoid overheating. Accordingly, in some examples, first and second regions of the heating target assembly are separated by an insulating boundary to reduce heat flow between the first and second regions. The first region may contain the first subset of heating targets and the second region may contain the second subset of heating targets. In a particular arrangement, the insulating boundary comprises a groove formed in the heating target assembly. The surface of the heating target assembly that contacts the hair may therefore have non-continuous surface.

In some examples, the heating system further comprises a battery power source to power the induction heating assembly.

In a specific example, the heating system is a heating device for heating hair, such as a hair styling device. Hair styling devices can include hair straightening devices used to straighten hair, hair curling devices used to curl hair, hair combing devices to comb hair or hair dryers for drying hair, for example.

In another example, the heating system is a heating device for heating air. The heating device may include a fan to move the air through the heating device and/or environment.

In another example, the heating system is a heating device for heating foodstuffs. For example, the heating device may be toaster or grill, such as a clam-shell grill. In another example, the heating system is an induction cooker where the heating target assembly is a pan or other receptacle. In another example, the heating system is device comprising a griddle plate, where the heating target assembly is the plate.

Further features and advantages of the invention will become apparent from the following description of preferred embodiments of the invention, given by way of example only, which is made with reference to the accompanying drawings.

### BRIEF DESCRIPTION OF THE DRAWINGS

FIG. 1 is a schematic diagram of a heating system comprising a target heating assembly with two subsets of heating targets, according to an example;

FIG. 2 is an example plot of drive frequency against time or the heating system of FIG. 1;

FIG. 3 is a schematic diagram of another heating system comprising a plurality of heating zones, according to an example;

FIG. 4 is a first example plot of drive frequency against time for the heating system of FIG. 3;

FIG. 5 is a second example plot of drive frequency against time for the heating system of FIG. 3;

FIG. 6 is a schematic diagram of an induction heating assembly configured to generate an asymmetric magnetic field, according to an example;

FIG. 7 is a schematic diagram of an asymmetric magnetic field generated by the induction heating assembly of FIG. 6;

FIG. 8 is a schematic diagram of a heating target assembly having a continuous heating surface, according to an example;

FIG. 9 is a schematic diagram of a heating target assembly having insulating boundaries between regions on the heating surface, according to an example;

FIG. 10 is a heat map of the temperature of an example heating target assembly in different regions; and

FIG. 11 is a perspective diagram of a hair straightening appliance, according to an example.

### DETAILED DESCRIPTION

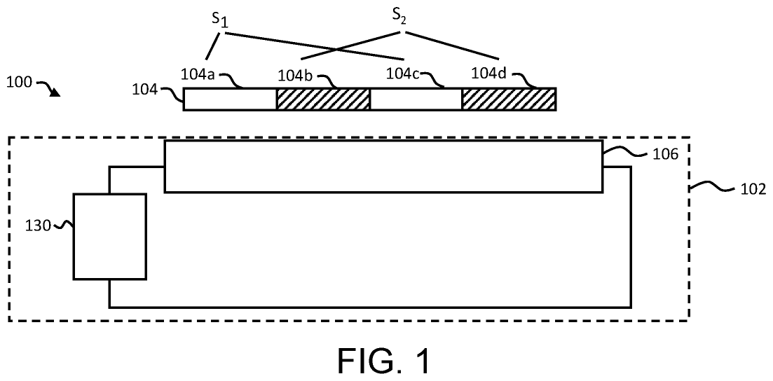

FIG. 1 is schematic diagram of a heating system 100 comprising an induction heating assembly 102 and a heating target assembly 104. The heating target assembly 104 comprises a plurality of heating targets 104a-b which can be heated by magnetic fields generated by the induction heating assembly 102. In this example, the heating target assembly 104 comprises a first subset S₁ of heating targets having a first resonant heating characteristic and a second subset S₂ of heating targets having a second resonant heating characteristic. The first subset S₁ of this example comprises two heating targets 104a, 104c but in other examples may comprise one or more heating targets. Similarly, the second subset S₂ of this example comprises two heating targets 104b, 104d but in other examples may comprise one or more heating targets. In the example shown, a heating target 104c from the first subset S₁ of heating targets is arranged between heating targets 104b, 104d from the second subset S₂ of the plurality of heating targets. Accordingly, different regions 104a-d of different heating targets are provided.

As previously discussed, the heating targets in each subset have different physical characteristics/properties which result in each subset having a different resonant heating characteristic.

The heating target assembly 104 of this example takes the form of a flexible heating plate, which can flex towards and/or away from the induction heating assembly 102, but in other examples the heating target assembly 104 may not be flexible and may not be moveable.

When the induction heating assembly 102 generates or is supplied with a high frequency alternating current, the induction heating assembly 102 generates an alternating/varying magnetic field that penetrates the heating target assembly 104. As mentioned, the magnetic field induces eddy currents within the electrically conductive heating target assembly 104 which causes the heating target assembly 104 to heat up.

In this example, the induction heating assembly 102 comprises a single heating zone comprising an induction coil assembly 106, which itself comprises one or more induction coils. The induction coil assembly 106 is supplied with the high frequency current to generate the magnetic fields. As will be discussed in more detail below, the induction coil assembly 106 has a top side that faces the heating target assembly 104, and a bottom side that faces away from the heating target assembly 104.

To generate and supply the high frequency current, the induction heating assembly 102 comprises a drive circuit 130. The drive circuit 130 is used to provide and control the current flow through the induction coil assembly 106. The alternating current provided to the induction coil assembly 106 by the drive circuit 130 is at a particular frequency, known as the drive frequency. As will be well understood, an induction coil forms part of one or more induction systems that can be driven to resonance, where each induction system has an associated resonant frequency.

In the example of FIG. 1, there is a first induction system which includes the induction heating assembly 102 and the first subset S₁ of heating targets, and a second induction system which includes the induction heating assembly 102 and the second subset S₂ of heating targets. The resonant frequency of the first induction system (the “first resonant frequency”) is based on several factors, such as the resonant heating characteristics of the heating targets within the first subset S₁. Similarly, the resonant frequency of the second induction system (the “second resonant frequency”) is based on the resonant heating characteristics of the heating targets within the second subset S₂. Changing the resonant heating characteristics of the heating targets in the first and second subsets S₁, S₂ changes the first and second resonant frequencies. Different resonant heating characteristics can be achieved by providing heating targets with different materials, thicknesses, dimensions, surface features or patterns, densities and/or permeabilities. In this particular example, the heating targets within the first subset S₁ are made from a first material and the heating targets within the second subset S₂ are made from a second, different material.

Accordingly, selecting heating targets with different resonant heating characteristics and varying the drive frequency of the induction heating assembly 102 allows selective heating of the heating targets within each subset. For example, when the drive frequency of the drive circuit 130 matches the resonant frequency of the first induction system, the heating targets in the first subset S₁ are heated resonantly. Thus, driving/operating the induction heating assembly 102 (i.e. the induction coil assembly 106) at this “first drive frequency” causes a first varying/alternating magnetic field to be generated. Similarly, when the drive frequency of the drive circuit 130 matches the resonant frequency of the second induction system, the heating targets in the second subset S₂ are heated resonantly. Thus, driving/operating the induction heating assembly 102 (i.e. the induction coil assembly 106) at this “second drive frequency” causes a second varying/alternating magnetic field to be generated. Accordingly, varying the drive frequency of the induction heating assembly 102 can heat the different subsets S₁, S₂.

In some examples, the drive frequency may be sufficiently close to the first resonant frequency such that the first subset S₁ of heating targets are heated, yet the drive frequency may be sufficiently far from the second resonant frequency such that the second subset S₂ of heating targets are not heated, or are heated to a temperature below the temperature of the first subset S₁of heating targets. Similarly, in other examples, the drive frequency may be sufficiently close to the second resonant frequency such that the second subset S₂ of heating targets are heated, yet the drive frequency may be sufficiently far from the first resonant frequency such that the first subset S₁ of heating targets are not heated, or are heated to a temperature below the temperature of the second subset S₂ of heating targets.

In examples where the heating target assembly 104 can move or flex, movement of the heating target assembly 104, or regions of the heating target assembly 104, relative to the induction heating assembly 102 may also cause the resonant frequency of the induction system(s) to change. Thus, should one or more heating targets 104a-b move closer or further away from the induction heating assembly 102, the resonant frequency of the induction system(s) would change. This may mean the drive frequency needs to be changed to ensure that the subset(s) are still heated effectively.

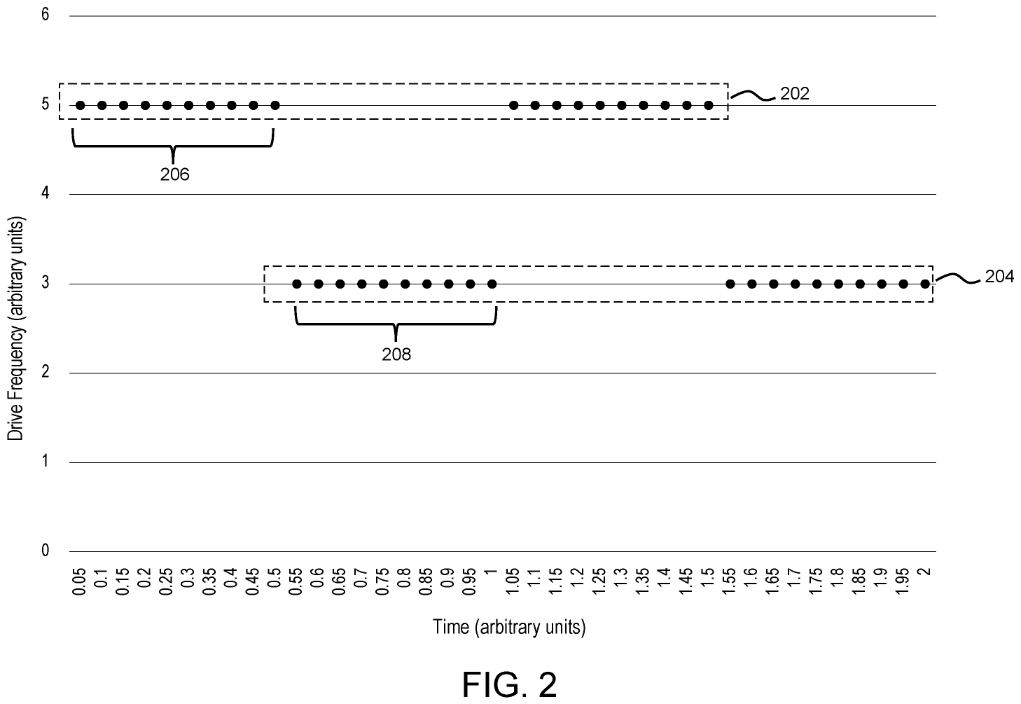

FIG. 2 shows an example plot of drive frequency against time. The plot shows how the drive frequency of the induction heating system 102 (or more particularly the drive frequency of the drive circuit 130) is varied between two drive frequencies (3 and 5) so that the first and second subsets S₁, S₂ of heating targets can be heated at different times. For example, in FIG. 1, the induction heating system 102 comprises a single heating zone to generate at least two different magnetic fields to heat both the first and second subsets S₁, S₂ of heating targets. To achieve this, the induction heating assembly 102 can be controlled to be driven at the first drive frequency 202 to generate the first magnetic field (to heat the first subset S₁) for a first time period 206 and the drive frequency can then be changed such that the induction heating assembly 102 is driven at the second drive frequency 204 to generate the second magnetic field (to heat the second subset S₂) for a second time period 208. The drive frequency therefore alternates between the first and second drive frequencies 202, 204 over time. In the example of FIG. 2, there is substantially no time gap between operating at the two different drive frequencies, but in some examples, there is a time gap, such that the first and second periods 206, 208 are spaced apart by the time tap. FIG. 2 goes on to show the drive frequency being changed back to the first drive frequency 202 after the end of the second period 208, and then again returning to the second drive frequency 204. The different drive frequencies associated with each subset S₁, S₂ are therefore multiplexed in time.

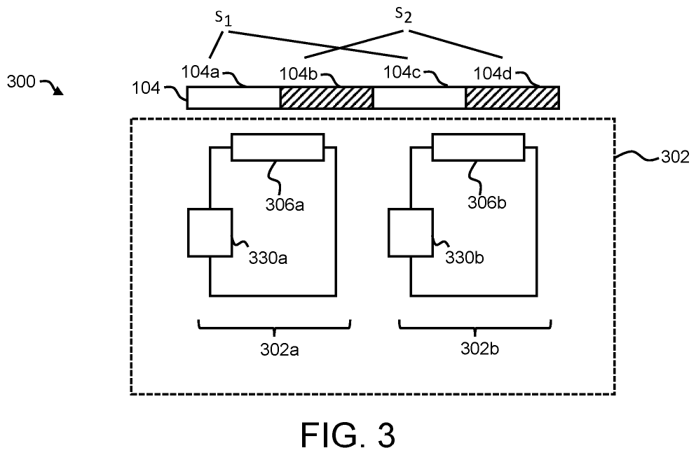

FIG. 3 is a schematic diagram of another heating system 300 comprising an induction heating assembly 302 and a heating target assembly 104. In this example, the heating target assembly 104 is the same as described and depicted in FIG. 1, but in other examples it may be different in form. The induction heating assembly 302 comprises a plurality of heating zones 302a, 302b. In this example, the induction heating assembly 302 comprises a first heating zone 302a configured to generate a first varying magnetic field to heat the first subset S₁ of heating targets and a second first heating zone 302b configured to generate a second varying magnetic field to heat the second subset S₂. In some examples, both heating zones can be operated together to heat just one subset.

In this example, each heating zone 302a, 302b comprises an inductor coil assembly 306a-b and a drive circuit 330a-b. Each heating zone 302a, 302b is therefore individually controllable. A single controller may control each heating zone 302a, 302b or a plurality of controllers may control the heating zones 302a, 302b. In this example, each heating zone 302a, 302b comprises its own controller to control the heating zone 302a, 302b. The controller(s) may control the drive frequency of the drive circuits 330a-b and/or control when the heating zone 302a, 302b is operative.

In some examples (not shown), a single drive circuit may drive all of the inductor coil assemblies 306a-b. For example, the inductor coil assemblies 306a-b may be connected in parallel and be driven by a single drive circuit that varies the drive frequency between a first drive frequency to drive the first heating zone and a second drive frequency to drive the second heating zone.

As mentioned above, each heating zone 302a, 302b and the respective subset S₁, S₂ of heating targets being heated by the heating zone 302a, 302b form part of a separate induction system having a particular resonant frequency based on the resonant heating characteristics of the heating targets in each subset S₁, S₂. For example, the first heating zone 302a and the first subset S₁ form part of a first induction system having a first resonant frequency and the second heating zone 302b and the second subset S₂ form part of a second induction system having a second resonant frequency. When the drive frequency of the first drive circuit 330a matches the resonant frequency of the first induction system, the heating targets in the first subset S₁ are heated resonantly. Similarly, when the drive frequency of the second drive circuit 330b matches the resonant frequency of the second induction system, the heating targets in the second subset S₂ are heated resonantly.

In one example, the first heating zone 302a is driven at the first drive frequency to generate the first magnetic field so as to heat the first subset S₁ of heating targets. At the same time, or at a later time, the second heating zone 302b is driven at the second drive frequency to generate the second magnetic field so as to heat the second subset S₂ of heating targets. Accordingly, varying the drive frequencies of the induction heating assembly 302 can heat the different subsets S₁, S₂ at the same or different times.

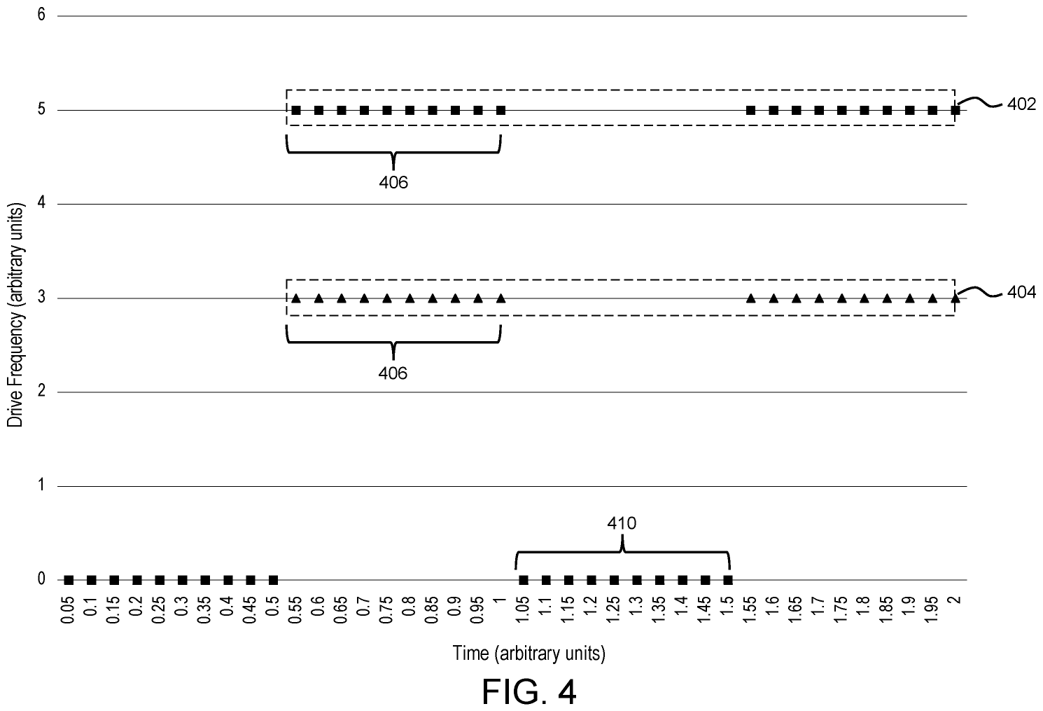

FIG. 4 shows a first example plot of drive frequency against time for the example heating system 300 of FIG. 3. The square markers show the drive frequency of the first heating zone 302a and the triangle markers show the drive frequency of the second heating zone 302b.

In this first example control scheme, the induction heating assembly 302 operates at two drive frequencies simultaneously because the induction heating assembly 302 has two heating zones 302a, 302b. For example, the first heating zone 302a is controlled to be driven at the first drive frequency 402 to generate the first magnetic field (to heat the first subset S₁) for a first time period 406 and simultaneously, the second heating zone 302b is controlled to be driven at the second drive frequency 404 to generate the second magnetic field (to heat the second subset S₂) for the same time period 406.

In the example of FIG. 4, there is a time gap 410 between subsequent heating pulses. During this period 410, the heating zones 302a, 302b are turned off (illustrated by a drive frequency of zero). In other examples, rather than turning off the heating zones 302a, 302b, the drive frequencies of both heating zones may be sufficiently far from the resonant frequencies of the induction systems so that “non-resonant” heating occurs. This time gap may be useful to avoid overheating the heating targets in each subset. In other examples however there may be substantially no time gap, such that the two heating zones operate continuously.

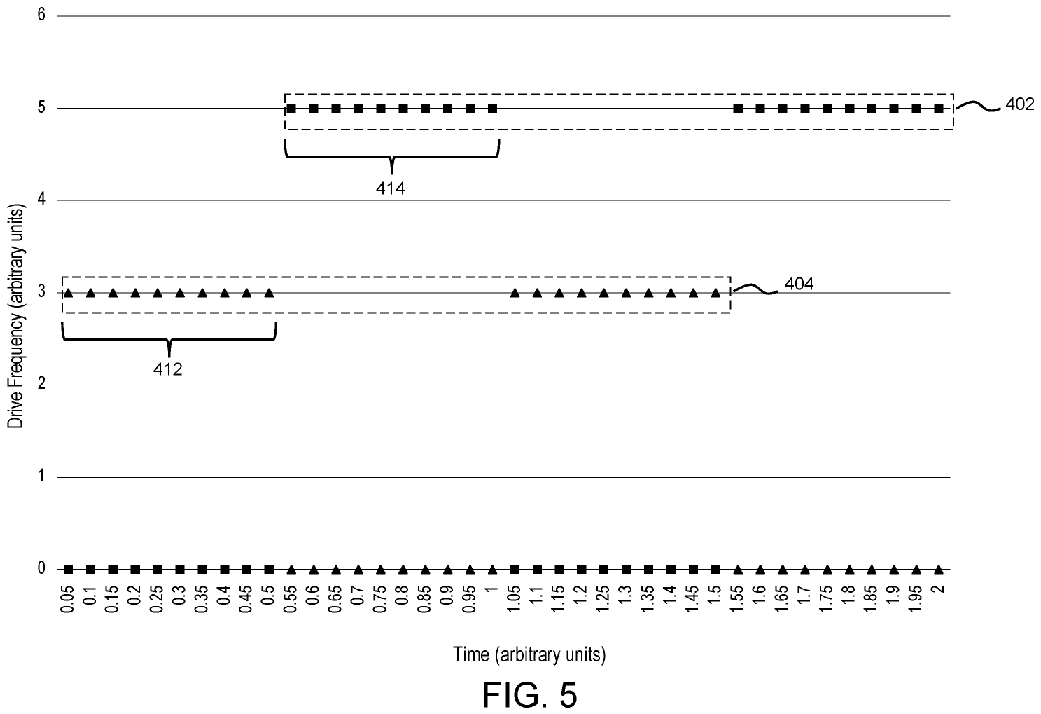

FIG. 5 shows a second example plot of drive frequency against time for the example heating system 300 of FIG. 3. The square markers show the drive frequency of the first heating zone 302a and the triangle markers show the drive frequency of the second heating zone 302b.

In this second example, unlike the example of FIG. 4, the induction heating assembly 302 operates at two drive frequencies at different times despite having two heating zones 302a, 302b. This may avoid interference, for example.

FIG. 5 shows the second heating zone 302b being controlled to be driven at the second drive frequency 404 to generate the second magnetic field (to heat the second subset S₂) for a second time period 412 and then the first heating zone 302a being controlled to be driven at the first drive frequency 402 to generate the first magnetic field (to heat the first subset S₁) for a first time period 414. The drive frequency therefore alternates between the first and second drive frequencies 202, 204 over time. When the first heating zone is active, the second heating zone is inactive and when the second heating zone is active, the first heating zone is inactive. When the heating zones are inactive, the heating zones 302a, 302b are turned off (illustrated by a drive frequency of zero). In other examples, rather than turning off the heating zones 302a, 302b, the drive frequencies may be sufficiently far from the resonant frequencies of the induction systems so that “non-resonant” heating occurs.

In the example of FIG. 4, there is substantially no time gap between operating at the two different drive frequencies, but in some examples, there is a time gap, such that the first and second periods 414, 412 are spaced apart by the time tap. FIG. 5 goes on to show the drive frequency alternating back and forth between the first and second drive frequencies 402, 404. The different drive frequencies associated with each subset S₁, S₂ are therefore multiplexed in time.

In some examples, such as examples where the heating target assembly 104 does not move or flex, the resonant frequency (and therefore the drive frequency) associated with each subset of heating targets may remain the same throughout the heating session. However, as mentioned, the resonant frequency of an induction system is based on the position of the heating target assembly relative to the induction heating assembly 102, 302 and so may change as the heating target assembly 104 moves or flexes. As the heating target assembly 104 moves, the resonant frequency may get closer or further away from the drive frequency. This may be useful as a method of controlling the level of heating, but in some circumstances, it may be useful to adjust or “tune” the drive frequency as the heating target assembly 104 moves to ensure that it substantially matches the resonant frequency as the resonant frequency changes. Thus, in addition to being dependent on the resonant heating characteristics of the heating targets, the drive frequency can also be selected based on the position of the heating target assembly 104 (or based on the position of a region of the heating target assembly 104) relative to the induction heating assembly 102, 302 as the device is used.

To achieve resonant heating of a subset S₁, S₂ of heating targets, the drive frequency would need to match the resonant frequencies of the induction systems, but because the resonant frequencies depend on the position of the subset relative to the induction heating assembly 102, 302, the resonant frequencies would need to be determined for each position.

In some examples, the resonant frequency at a particular position and moment in time can be determined/calculated by measuring the current and/or voltage at certain locations within the circuit and inputting these parameters into well known, standard equations. Once the resonant frequency is known, the drive circuit 130, 330 can adjust the drive frequency to match the determined resonant frequency. If the position of the heating target assembly 104 moves again, the same process can be repeated so that the drive frequency is adjusted as the heating target assembly 104 moves. A controller can determine the resonant frequency and therefore the drive frequency and responsively cause the induction heating assembly 102, 302 to operate at the selected drive frequency.

Alternatively, rather than determining the resonant frequency through measurement of the circuit parameters, the resonant frequency may be obtained from a lookup table based on a measured position of the heating target assembly 104 being heated. For example, one or more light sensors (not shown) may measure a distance between the heating target assembly 104 and the induction heating assembly 102, 302. Based on a previous calibration or calculation, specific measured distances may correspond to specific resonant frequencies and therefore specific drive frequencies. A lookup table stored in memory of a controller may store an association between the measured distances and the resonant frequencies and/or drive frequencies, so that the desired drive frequency can be selected to resonantly heat the heating target assembly 104. If the position of the heating target assembly 104 moves again, the same process can be repeated so that the drive frequency is adjusted as the heating target assembly 104 moves. A controller can determine the resonant frequency and therefore the drive frequency and responsively cause the induction heating assembly 102, 302 to operate at the selected drive frequency.

In another example, the system can be designed to ensure that the required power range is available by adjusting operating frequency, and the induction heating assembly can be operated below resonance (which also saves power). When the temperature of the heating target assembly falls below a target value, the drive frequency can be increased, passing more power into the target by moving closer to resonance and increasing the temperature towards the target value. In one example, each of the zones are associated with an operating frequency range, and a temperature control loop determines the drive frequency. Thus, by measuring the temperature and adjusting the frequency, control can be achieved.

In some examples of the invention, the magnetic field generated by the induction heating assembly 102, 302 is asymmetric, meaning that the magnetic field strength at the top side of the induction heating assembly (i.e. the induction coil assembly 106, 306) is substantially greater than the magnetic field strength at the bottom side. Thus, a greater percentage of the magnetic flux impinges the heating target assembly when compared to a symmetric magnetic field.

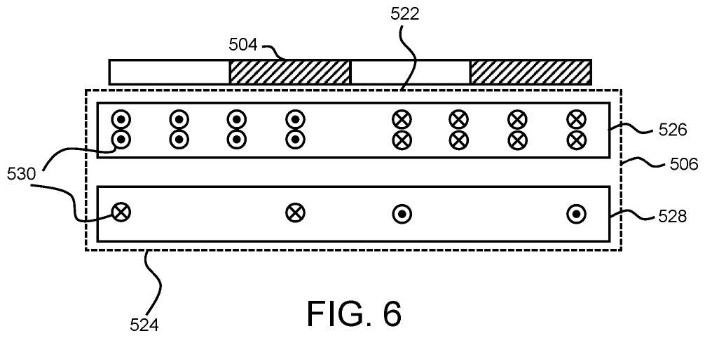

The particular induction heating assembly depicted in FIG. 6 generates an asymmetric magnetic field and comprises an induction coil assembly 506 having a number of windings of a conductor 530. In this example, the conductor 530 is a litz wire comprising a plurality of twisted wire strands. As is well known, a litz wire is designed to reduce high frequency AC losses, such as skin and proximity effects within the conductor. To achieve the asymmetric magnetic field, the induction coil assembly comprises a power coil layer 526 and a screening coil layer 528. In general terms, the power coil layer 526 is designed to generate a sufficiently strong magnetic field to heat the heating target assembly 504, and the screening coil layer 528 is designed to generate an opposing magnetic field to cancel out or sufficiently reduce the magnetic flux passing out of the bottom side 524 of the induction heating assembly 102, 302. At any point along the induction coil assembly 506, the current passing through the conductor windings in the screening coil layer 528 is opposite to the current passing through the conductor windings in the power coil layer 526. The current flowing in the opposite direction in the screening coil layer 528 creates an opposing magnetic field.

In FIG. 6, the power coil layer 526 comprises two layers of four windings of a single conductor 530 which form a spiral shape when viewed from above. The conductor 530 is therefore wound into and out of the page. In windings where the current flows out of the page at an instance in time, the conductor 530 is shown illustrated with a dot in its centre. In windings where the current flows into the page at the same instance in time, the conductor 530 is shown with a cross. It will be understood that the current is alternating, so the direction of the current is reversed in accordance with a drive frequency. The screening coil layer 528 comprises one layer of two windings of the same conductor 530. To ensure that the magnetic field is asymmetric, the current density in the power coil layer 526 is greater than the current density in the screening coil layer 528. The magnetic field created by the power coil layer 526 is therefore stronger than the magnetic field created by the screening coil layer 528. The form of the magnetic field can be adjusted by altering the current density and/or positions of the conductors 530 in each layer 526, 528. Accordingly, it will be appreciated that the number of windings in each coil layer 526, 528 may be different to that illustrated in FIG. 6.

In this particular example, a single conductor 530 forms both the power coil 526 and the screening coil layer 528. In other examples, two or more conductors may be used. For example, a single conductor may form the power coil layer 526 and a different conductor may form the screening coil layer 528. In some examples, two or more conductors may be used within each layer 526, 528.

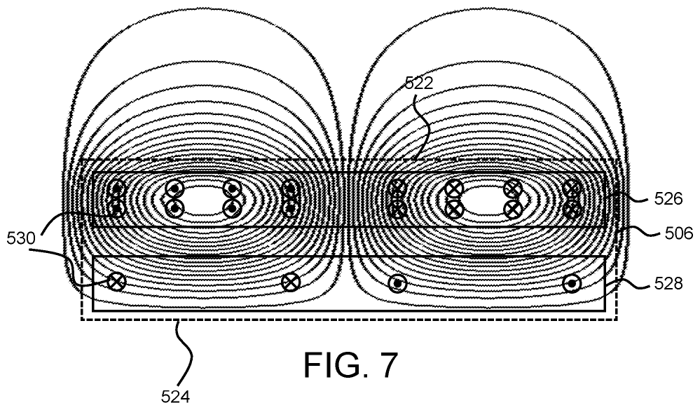

FIG. 7 depicts an example asymmetric magnetic field generated by the induction heating assembly of FIG. 6. The heating target assembly 504 is omitted so that the single sided nature of the magnetic field is more clearly visible. Introducing the heating target assembly 504 would distort the magnetic field from that shown in FIG. 7 (particularly in the top side 522) as the magnetic flux is absorbed by the heating target assembly 504.

The magnetic fields generated by the power coil layer 526 and the screening coil layer 528 combine to produce an overall asymmetric magnetic field which has a magnetic field strength at the top side 522 of the induction coil assembly 506 that is substantially greater than the magnetic field strength at the bottom side 524. Visually, this asymmetric magnetic field is shown by no, or a reduced number of magnetic field lines extending beyond the bottom side 524 of the induction coil assembly 506. As such, a high proportion of the magnetic energy is directed towards the induction heating target assembly 504 and the magnetic flux escaping the device is greatly reduced. Having an asymmetric magnetic field means that magnetic shielding within the device can be omitted or reduced in thickness.

The example induction coil assembly 506 and therefore the generated asymmetric magnetic field can be incorporated into any of the heating systems 100, 300 discussed above. For example, in FIG. 3, one or more of the heating zones 302a, 302b may incorporate the induction coil assembly 506 of FIGS. 6 and 7.

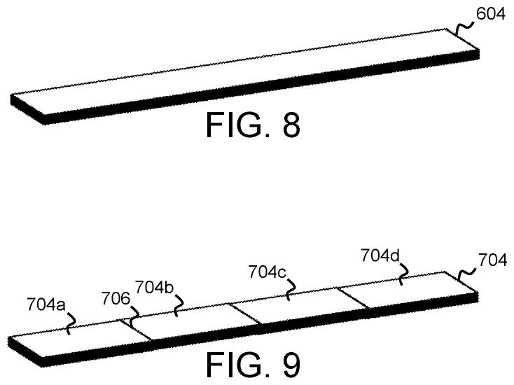

As discussed above, some regions of the heating target assembly may be heated to a greater extent than other regions, either due to movement of the region, the use of a plurality of heating zones and/or use of different heating targets with different resonant characteristics. In some examples, it may be useful to limit heat flow between adjacent regions. Therefore, in some examples, a surface of the heating target assembly may have one or more insulating boundaries separating different regions on the heating target assembly to reduce heat flow between regions. FIG. 8 depicts a heating target assembly 604 without insulating boundaries, whereas FIG. 9 depicts an insulating boundary 706 between each region. For example, FIG. 9 depicts an insulating barrier 706 separating the first and second regions 704a, 704b. In this particular arrangement, the insulating boundary is a groove formed on the heating target assembly such that the surface of the heating target assembly that contacts the entity being heated, such as hair, may have a non-continuous surface. The groove may be integrally formed, or may be etched or milled from the heating target assembly 704. Insulating boundaries may be incorporated into any of the heating target assemblies described above. In a particular example, the heating target assembly comprises an insulating boundary between heating targets having the first resonant characteristic and heating targets having the second resonant characteristic. Thus, the first region 704a may comprise heating targets from the first subset S1 and the second region 704b may contain heating targets from the second subset S₂.

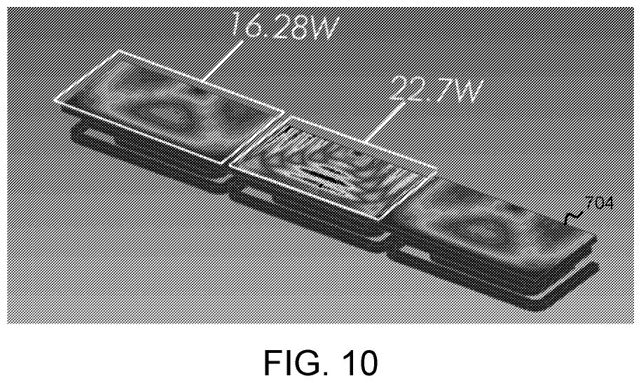

FIG. 10 depicts a heat map of the surface of an example heating target assembly having three regions. In a particular example, the central region may comprise heating targets of the first subset S₁ and the two outer regions may comprise heating targets of the second subset S₂. In this example, the drive frequency substantially matches the resonant frequency of the induction system comprising the first subset S₁ such that the heating targets of the first subset S₁ are being heated resonantly. The temperature of the heating target assembly 704 in this central region is therefore higher than that of the two adjacent regions which are not being heated resonantly and are separated by insulating boundaries.

As briefly mentioned throughout, the heating systems described above may be incorporated into a wide variety of devices/appliances. In one example, the heating system forms part of a hair styling device, such as a hair straightening device.

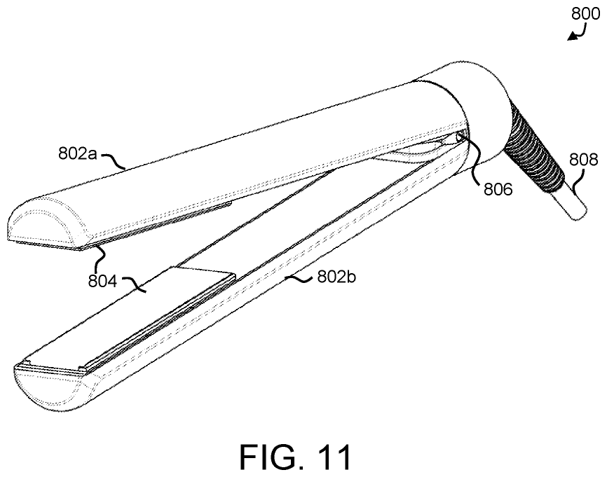

FIG. 11 is a perspective view of an example hair straightening device 800 comprising a first arm 802a and a second arm 802b, which are joined together at one end by a hinge 806. A power supply cable 808 extends away from the hinged end of the hair straightening device 800. In other examples, the hair straightening device 800 comprises an internal battery power source, such that the power supply cable 808 is omitted.

Each arm 802a, 802b comprises an heating target assembly 804 located towards the end of the arm furthest away from the hinge 806. Inside each arm is an induction heating assembly to heat the heating target assembly 804. FIG. 11 shows the hair straightening device 800 in an open position where the heating target assemblies 804 are spaced apart. The heating target assemblies 804 are arranged to contact each other when the first and second arms 802a, 802b are brought together by a user into a closed position. The heating target assemblies 804 comprise a hair contacting surface which contacts hair, in use. Hair that is to be straightened is trapped between the two heating target assemblies 804 and heat is transferred to the hair from the heating target assemblies 804.

The above examples are to be understood as illustrative. Further examples are envisaged. Any feature described in relation to any one example may be used alone, or in combination with other features described, and may also be used in combination with one or more features of any other of the examples, or any combination of any other of the examples. Furthermore, equivalents and modifications not described above may also be employed without departing from the scope of the invention, which is defined in the accompanying claims.

1. A heating system, comprising:
an induction heating assembly configured to generate varying magnetic fields;
a heating target assembly comprising a plurality of heating targets, the plurality of heating targets being heatable by penetration with a varying magnetic field, wherein a first subset of the plurality of heating targets has a first resonant heating characteristic and a second subset of the plurality of heating targets has a second resonant heating characteristic, the first and second resonant heating characteristics being different; and
a controller configured to:
control the induction heating assembly based on the first resonant heating characteristic to generate a first varying magnetic field to heat the first subset; and
control the induction heating assembly based on the second resonant heating characteristic to generate a second varying magnetic field to heat the second subset.

2. The heating system according to claim 1, wherein to control the induction heating assembly, the controller is configured to:
cause the induction heating assembly to be driven at a first drive frequency to generate the first magnetic field; and
cause the induction heating assembly to be driven at a second drive frequency to generate the second magnetic field;
wherein the first and second drive frequencies are based on at least the first and second resonant heating characteristics.

3. The heating system according to claim 2, wherein the induction heating assembly comprises a first heating zone and a second heating zone, the first heating zone being configured to generate the first varying magnetic field and the second heating zone being configured to generate the second varying magnetic field, and wherein to control the induction heating assembly, the controller is configured to:
cause the first heating zone to be driven at the first drive frequency to generate the first magnetic field; and
cause the second heating zone to be driven at the second drive frequency to generate the second magnetic field.

4. The heating system according to claim 2, wherein to control the induction heating assembly, the controller is configured to:
cause the induction heating assembly to be driven at the first drive frequency to generate the first magnetic field for a first time period; and
cause the induction heating assembly to be driven at the second drive frequency to generate the second magnetic field for a second time period.

5. The heating system according to claim 4, wherein the first and second time periods are both less than about 1 s.

6. The heating system according to any of claims 2, wherein the plurality of heating targets are moveable relative to the induction heating assembly, and wherein at least one of:
the first drive frequency is further based on the position of the first subset of the plurality of heating targets relative to the induction heating assembly; and
the second drive frequency is further based on the position of the second subset of the plurality of heating targets relative to the induction heating assembly.

7. The heating system according to claim 6, wherein at least one of:
the first drive frequency is varied as the position of the first subset of the plurality of heating targets moves relative to the induction heating assembly; and
the second drive frequency is varied as the position of the second subset of the plurality of heating targets moves relative to the induction heating assembly.

8. The heating system according to claim 1, wherein the first subset of the plurality of heating targets and the induction heating assembly form a first induction system having a first resonant frequency based on at least the first resonant heating characteristic and the second subset of the plurality of heating targets and the induction heating assembly form a second induction system having a second resonant frequency based on at least the second resonant heating characteristic.

9. The heating system according to claim 1, wherein the first and second resonant heating characteristics are based on at least one of:
materials of the one or more heating targets in the first or second subsets;
thicknesses of the one or more heating targets in the first or second subsets;
densities of the one or more heating targets in the first or second subsets; and
permeabilities of the one or more heating targets in the first or second subsets.

10. The heating system according to claim 1, wherein at least one heating target from the first subset of the plurality of heating targets is arranged between heating targets from the second subset of the plurality of heating targets.

11. A The heating system according to claim 2, wherein a difference between the first and second drive frequencies is greater than about 10 KHz.
